(19) United States
(12) Patent Application Publication
(10) Pub. No.: US 2018/0334823 A1
(43) Pub. Date: Nov. 22, 2018

(54) Positive Circulation Filtering Device

(71) Applicant: Bob Pulley, Double Oak, TX (US)

(72) Inventor: Bob Pulley, Double Oak, TX (US)

(21) Appl. No.: 15/598,117

(22) Filed: May 17, 2017

(51) Int. Cl. E04H 4/12; C02F 1/00; B01D 29/56; B01D 35/28; B01D 35/30

(52) U.S. Cl. CPC E04H 4/1263; C02F 1/001; C02F 2103/42; B01D 35/28; B01D 35/30; B01D 29/56

(57) ABSTRACT

A filter container to filter a fluid may include a first section having a porous first wall; a second section having a porous second wall being connected to the porous first wall; and a hose to connect to the first section and to connect to a skimmer to transport the fluid to the filter. The first section and the second section define a central cavity.

### FIELD OF THE INVENTION

The present invention relates to a skimmer and more particularly to a skimmer device to filter water from a swimming pool.

### BACKGROUND

A swimming pool can be a source of enjoyment for all the members of a family, and there may be hundreds of thousands of the swimming pools in the United States alone. A source of maintenance for these swimming pools is the need to remove debris such as leaves and other objects from the pool. The leaves will become waterlogged and sink below the surface of the water. Typically, the pool will have a skimmer to remove the debris from the pool working in conjunction with a filter to keep the pool free from debris. An another problem with pools during the colder seasons is keeping ice from freezing across the surface of the water. This ice can result in damage to the walls of the pool and mechanical equipment such as the pump.

In order to prevent the ice from forming on the surface of the pool, the pump may be operated with or without a heater to keep the temperature of the pool water from dropping below freezing. If there is a significant amount of leaves in the pool water, the leaves can block the skimmer/skimmers from allowing the water to pass through. Without the flow of water, the heater will become ineffective and the temperature of the water may drop below freezing, causing the damage to the pool itself. An alarm may be installed to be activated when the temperature of the water drops to a predetermined point. However, correcting this situation in cold weather and possibly late at night is highly undesirable.

There is a need for a skimmer device which will prevent leaves and other debris from entering the pool filter.

### SUMMARY

A filter container to filter a fluid may include a first section having a porous first wall; a second section having a porous second wall being connected to the porous first wall; and a hose to connect to the first section and to connect to a filter to transport the fluid to the filter. The first section and the second section define a central cavity.

The first section may include a first depression wall to connect to the porous first wall.

The second section may include a second depression wall to connect to the porous second wall.

The first section and the second section may be connected with a fastener.

The first porous wall may include a grid.

The second porous wall may include a grid.

The grid may include a strip.

The grid may include a wire.

The grid may include a strip.

The grid may include a wire.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of the filtering device of the present invention;

FIG. 2 illustrates an exploded view of the filtering device of the present invention;

FIG. 3 illustrates an end view of the filtering device of the present invention;

FIG. 4 illustrates another end view of the filtering device of the present invention.

### DETAILED DESCRIPTION

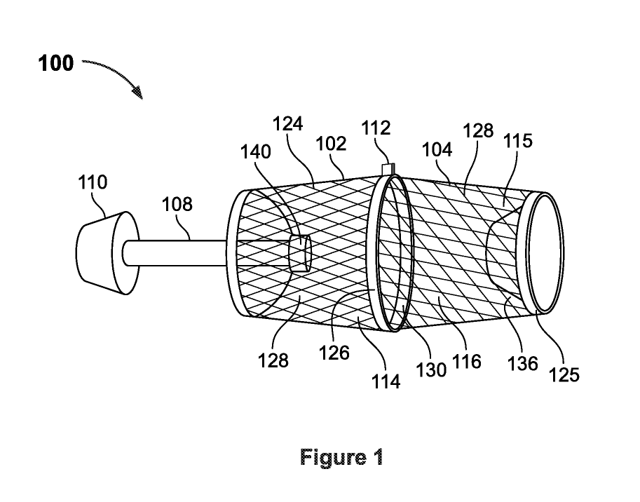

The filtering device 100 of the present invention may be used in a swimming pool to prevent the skimmer 110 of the swimming pool from becoming clogged due to leaves and other debris and preventing the continuous circulation of water (or other fluid). The continuous circulation prevents the water in the swimming pool from freezing avoiding damage. FIG. 1 illustrates the filtering device 100 which may include an integral device and/or it may include a first section 102 which may be detachably/replaceable connected to a second section 104 and which may be pivotably connected to the second section 104. The first section 102 and the second section 104 may be held together with a fastener 112 to prevent the first section 102 from separating from the second section 104. The first section 102 may be a truncated cone shape (the shape may be a cylinder, rectangle, spherical or other appropriate shape) and may include a peripheral first peripheral wall 114 to allow water (or other fluid) to enter the central cavity 116.

The second section 104 may be a truncated cone shape (the shape may be a cylinder, rectangle, spherical or other appropriate shape) and may include a peripheral second peripheral wall 115 to allow water (or other fluid) to enter the central cavity 116.

The filter container 100 may be placed beneath the surface of the water in the pool and may be connected to the skimmer 110. The pump (not shown) may pool water through the filter and through the filter container 100. Leaves may not enter the filter container 100 because of the grid 122.

The filter container 100 may be formed from a single integral filter container in another embodiment.

The filter container including the first section 102 may be formed from a grid 122 of wire/strips 124 to form the porous peripheral first wall 114, and the second section 104 may form the same or slightly different grid 122 of wire/strips 124 to form the porous peripheral second wall 115. The porous first wall 114 may include a first depression wall 125 which may be concavely shaped. The porous first wall 114 may have an opening 126 into the first cavity 128 (a portion of the central cavity 116) at an end of the first wall 114. The periphery of the first opening 126 may engage the periphery of the second opening 130 and may open into the second cavity 132 (a portion of the central cavity 116). The porous second wall 115 may connect with a second depression wall 136 which may be concavely shaped.

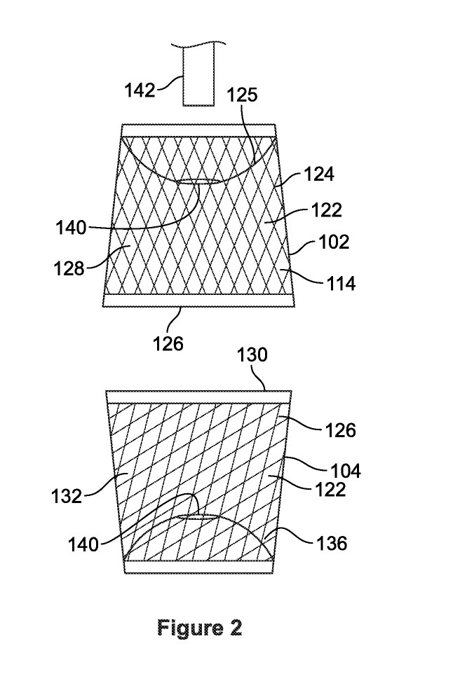

The first depression wall 125 may include a socket 140 extending through the first depression wall to connect to a hose 108 which connects to the skimmer 110. (Shown in FIG. 2)

FIG. 1 illustrates the filtering device 100 which may include an integral device and/or it may include a first section 102 which may be detachably/replaceable connected to a second section 104 and which may be pivotably connected to the second section 104. The first section 102 and the second section 104 may be held together with a fastener 112 to prevent the first section 102 from separating from the second section 104. The first section 102 may be a truncated cone shape (the shape may be a cylinder, rectangle, spherical or other appropriate shape) and may include a peripheral first peripheral wall 114 to allow water (or other fluid) to enter the central cavity 116.

The second section 104 may be a truncated cone shape (the shape may be a cylinder, rectangle, spherical or other appropriate shape) and may include a peripheral second peripheral wall 115 to allow water (or other fluid) to enter the central cavity 116.

The filter container 100 may be formed from a single integral filter container in another embodiment.

The filter container including the first section 102 may be formed from a grid 122 of wire/strips 124 to form the porous peripheral first wall 114, and the second section 104 may form the same or slightly different grid 122 of wire/strips 124 to form the porous peripheral second wall 115. The porous first wall 114 may include a first depression wall 125 which may be concavely shaped. The porous first wall 114 may have an opening 126 into the first cavity 128 (a portion of the central cavity 116) at an end of the first wall 114. The periphery of the first opening 126 may engage the periphery of the second opening 130 and may open into the second cavity 132 (a portion of the central cavity 116). The porous second wall 115 may connect with a second depression wall 136 which may be concavely shaped.

The first depression wall 125 may include a socket 140 extending through the first depression wall to connect to a hose 108 which connects to the skimmer 110. (Shown in FIG. 2)

The filter container 100 may be placed beneath the surface of the water in the pool and may be connected to the skimmer 110. The pump (not shown) may pool water through the filter and through the filter container 100. Leaves may not enter the filter container 100 because of the grid 122.

FIG. 2 illustrates an exploded view of the filtering device 100 which may include an integral device and/or it may include a first section 102 which may be detachably/replaceable connected to a second section 104 and which may be pivotably connected to the second section 104. The first section 102 and the second section 104 may be held together with a fastener 112 to prevent the first section 102 from separating from the second section 104. The first section 102 may be a truncated cone shape (the shape may be a cylinder, rectangle, spherical or other appropriate shape) and may include a peripheral first peripheral wall 114 to allow water (or other fluid) to enter the central cavity 116.

The second section 104 may be a truncated cone shape (the shape may be a cylinder, rectangle, spherical or other appropriate shape) and may include a peripheral second peripheral wall 115 to allow water (or other fluid) to enter the central cavity 116.

The filter container 100 may be formed from a single integral filter container in another embodiment.

The filter container including the first section 102 may be formed from a grid 122 of wire/strips 124 to form the porous peripheral first wall 114, and the second section 104 may form the same or slightly different grid 122 of wire/strips 124 to form the porous peripheral second wall 115. The porous first wall 114 may include a first depression wall 125 which may be concavely shaped. The porous first wall 114 may have an opening 126 into the first cavity 128 (a portion of the central cavity 116) at an end of the first wall 114. The periphery of the first opening 126 may engage the periphery of the second opening 130 and may open into the second cavity 132 (a portion of the central cavity 116). The porous second wall 115 may connect with a second depression wall 136 which may be concavely shaped.

The first depression wall 125 may include a socket 140 extending through the first depression wall and into the central cavity 116 to connect to a hose 108 which connects to the skimmer 110. (Shown in FIG. 2)

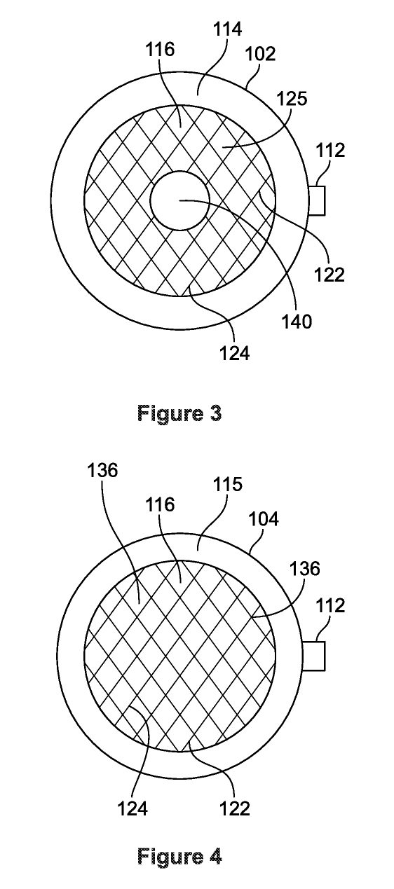

FIG. 3 illustrates an end view of the first section 102 of the filter container 100 of the present invention.

FIG. 3 illustrates the socket 104 to connect to the hose 108 (not shown in FIG. 3), the grid 122, the strips 124 of the grid 122 to form the porous wall, the first porous wall 114, the central cavity 116, the fastener 112, the first depression wall 125

FIG. 4 illustrates an end view of the second section 104 of the filter container 100 of the present invention.

FIG. 4 illustrates the grid 122, the strips 124 of the grid 122 to form the porous wall, the second porous wall 115, the central cavity 116, the fastener 112, the second depression wall 136.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A filter container to filter a fluid, comprising:
a first section having a porous first wall;
a second section having a porous second wall being connected to the porous first wall;
a hose to connect to the first section and to connect to a skimmer to transport the fluid to the filter;
wherein the first section and the second section define a central cavity.

2) A filter container to filter a fluid as in claim 1, wherein the first section includes a first depression wall to connect to the porous first wall.

3) A filter container to filter a fluid as in claim 1, wherein the second section includes a second depression wall to connect to the porous second wall.

4) A filter container to filter a fluid as in claim 1, wherein the first section and the second section are connected with a fastener.

5) A filter container to filter a fluid as in claim 1, wherein the first porous wall includes a grid.

6) A filter container to filter a fluid as in claim 1, wherein the second porous wall includes a grid.

7) A filter container to filter a fluid as in claim 5, wherein the grid includes a strip.

8) A filter container to filter a fluid as in claim 5, wherein the grid includes a wire.

9) A filter container to filter a fluid as in claim 6, wherein the grid includes a strip.

10) A filter container to filter a fluid as in claim 6, wherein the grid includes a wire.
